(19) United States
(12) Patent Application Publication
(10) Pub. No.: US 2025/0180292 A1
(43) Pub. Date: Jun. 5, 2025

(54) STACK MELTING APPARATUS

(71) Applicant: PYROTEK, INC., Spokane, WA (US)

(72) Inventors: Michael TOMASSI, East Syracuse, NY (US); Dennis SANDERS, Trenton, TN (US); Scott DENNING, Fort Wayne, IN (US)

(21) Appl. No.: 18/840,674

(22) PCT Filed: Feb. 21, 2023
(86) PCT No.: PCT/US2023/013524

§ 371 Date: Aug. 22, 2024

Related U.S. Application Data
(60) Provisional application No. 63/312,482, filed on Feb. 22, 2022.

(51) Int. Cl. F27B 3/04; B22D 21/04; B22D 41/01; B22D 43/00; F27D 13/00; F27D 19/00

(52) U.S. Cl. CPC F27B 3/045; B22D 41/01; F27D 13/002; B22D 21/04; B22D 43/00; F27D 2019/0003; F27D 2019/0037; F27D 2019/0043

(57) ABSTRACT

An integrated aluminum melting and holding system is provided. The system includes, in combination, a hearth for receiving and melting a charge of aluminum pieces, a holding chamber for maintaining the elevated temperature for casting, and a well to allow removal of the molten aluminum for delivery to a casting station. The hearth includes a combustion chamber having a fuel burner section communicating with the hearth for burning hydrocarbon fuel with air to produce effluent hot gases in the burner section for circulation through the hearth for melting the aluminum pieces. The holding chamber receives molten aluminum from the hearth. The holding chamber has at least a substantial portion positioned below a substantial portion of the hearth. The holding chamber includes at least one immersion heater in contact with the molten aluminum. The holding chamber further includes a lid configured to contact the molten aluminum disposed within the holding chamber. The open top well is in fluid communication with the holding chamber for receiving the molten aluminum.

### BACKGROUND

This application claims the benefit of U.S. Provisional Application No. 63/312,482 filed Feb. 22, 2022, the disclosure of which is herein incorporated by reference.

This invention relates to an integrated aluminum melting system characterized by improved thermal efficiency, improved prevention of oxide formation, and to a process of melting aluminum in which the amount of thermal energy employed per pound of aluminum melted is substantially reduced.

Existing fuel fired aluminum melting furnaces are generally direct fired with gases emitted at relatively high temperatures. A conventional melting furnace may utilize hot gases formed by the combustion of carbonaceous materials, e.g. hydrocarbons, such as fuel oil, natural gas, powdered coal and the like, to produce temperatures in the range of 3000° F. to 3400° F., the exhaust gases delivered to the stack generally ranging in temperature from about 2000° F. to 2500° F.

Aluminum scrap, such as turnings, borings, grindings and other forms of machinings, and aluminum ingot and in fact any source of aluminum can be used in the apparatus of the present disclosure.

When using conventional direct fired furnaces of the type utilizing high temperature gases referred to hereinabove, it is not uncommon for the fuel input to correspond to about 2000 to 3500 BTU's/hr/lb of aluminum melted, the thermal efficiency of the operation being rather low, for example, less than 30%, the thermal efficiency in many instances ranging from about 10% to 20%. The present apparatus provides an improved efficiency system that lessens the formation of oxides by incorporating a unique burner configuration and by reducing exposure of the molten aluminum to oxygen.

The present stack melting system advantageously reduces the introduction of unwanted oxides, efficiently melts and heats the aluminum, and provides a integrated system suitable for feeding molten aluminum to one or two casting stations.

### BRIEF DESCRIPTION

According to an embodiment of the disclosure, an integrated aluminum melting and holding system is provided. The system includes, in combination, a hearth for receiving and melting a charge of aluminum pieces, a holding chamber for maintaining the elevated temperature for casting, and a well to allow removal of the molten aluminum for delivery to a casting station. The hearth includes a combustion chamber having a fuel burner section communicating with the hearth for burning hydrocarbon fuel with air to produce effluent hot gases in the burner section for circulation through the hearth for melting the aluminum pieces. The holding chamber receives molten aluminum from the hearth. The holding chamber has at least a substantial portion positioned below a substantial portion of the hearth. The holding chamber includes at least one immersion heater in contact with the molten aluminum. The holding chamber further includes a lid configured to contact the molten aluminum disposed within the holding chamber. The open top well is in fluid communication with the holding chamber for receiving the molten aluminum.

### BRIEF DESCRIPTION OF THE DRAWINGS

It is thus the intention of this disclosure to provide an aluminum melting system and a process for melting metal, e.g. aluminum, under conditions of improved thermal efficiency and reduced oxidation losses.

These and other intentions will more clearly appear from the following disclosure, the claims and the accompanying drawings, wherein:

FIG. 1 is a front side perspective view of the stack-melter of the present disclosure;

FIG. 2 is a rear side perspective view thereof with a lid of the holding chamber removed;

FIG. 3 is a further side perspective view thereof with partial cross-sectional display of the holding chamber and dip well;

FIG. 4A is a top cross-section view of the stack-melter;

FIG. 4B is taken along line B-B of FIG. 4A;

FIG. 4C is taken along line C-C of FIG. 4A;

FIG. 4D is a side cross-section view of the stack-melter;

FIG. 5A is a top view of the wet roof holder and dip well component, partially in cross-section, of the stack-melter;

FIG. 5B is a cross-section view of the wet roof holder and dip well; and

FIG. 5C is a sideview, partially in cross-section, of the wet roof holder and dip well.

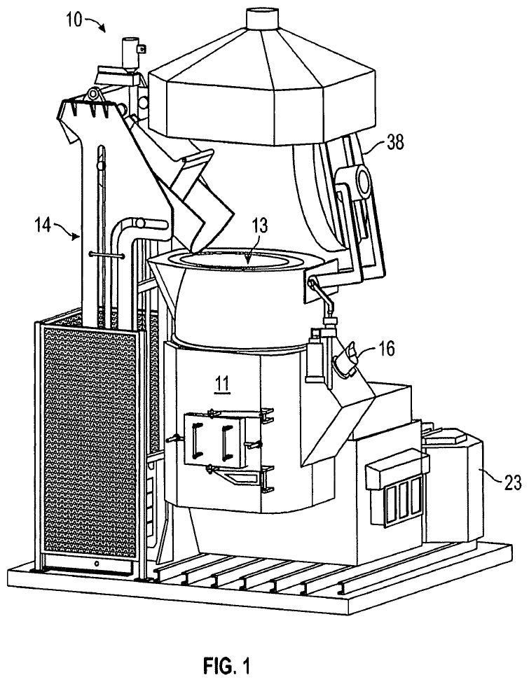

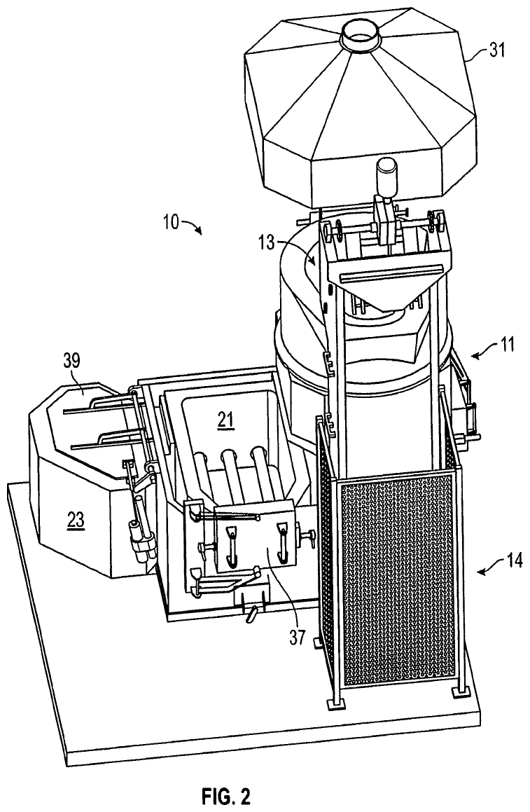

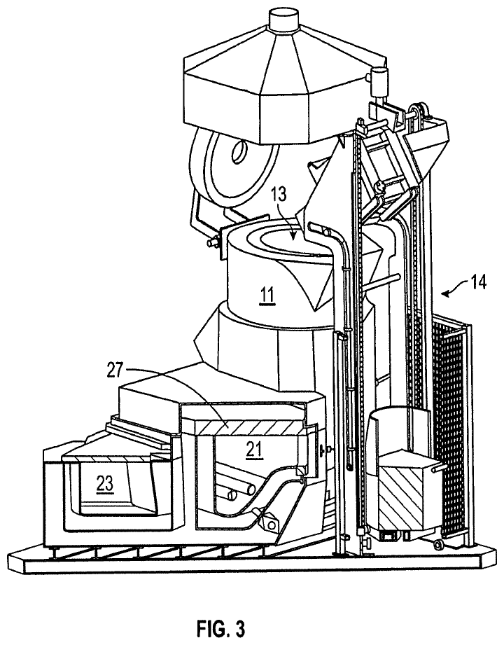

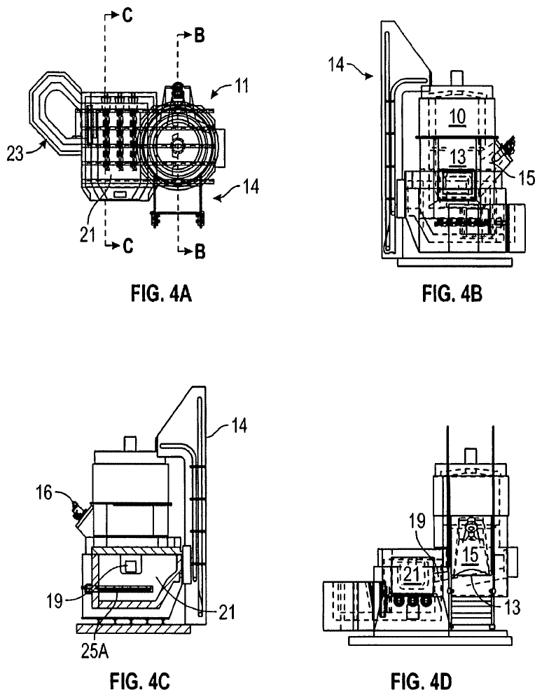

### DETAILED DESCRIPTION

Certain of the components utilized in this invention are widely known and used in the field of the invention described, and their exact nature or type is not necessary for an understanding and use of the invention by a person skilled in the art or science; therefore, they will not be discussed in significant detail.

A more complete understanding of the components, processes and apparatuses disclosed herein can be obtained by reference to the accompanying drawings. The figures, which are merely schematic representations, are provided for convenience and the ease of demonstrating the present disclosure, and are, therefore, not intended to indicate relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The singular forms “a,” “an,” and “the” include plural referents unless the context clearly dictates otherwise.

As used in the specification and in the claims, the terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing kits or devices or methods as “consisting of” and “consisting essentially of” the enumerated components/steps, which allows the presence of only the named components/steps, and excludes other components/steps.

Numerical values in the specification and claims of this application should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values).

A value modified by a term or terms, such as “about” and “substantially,” may not be limited to the precise value specified. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number.

The terms “upper” and “lower” may be used to indicate relative direction to each other in location, i.e. an upper component is located at a higher elevation than a lower component.

The terms “horizontal” and “vertical” may be used to indicate direction relative to an absolute reference, i.e. ground level. However, these terms should not be construed to require similarly-described structures to be absolutely parallel or absolutely perpendicular to each other.

One embodiment of the invention resides in a process for improving the efficiency of melting aluminum in a melting furnace, the process comprising providing a furnace having a melting hearth therein communicating with a combustion chamber by means of which said hearth is heated to a temperature sufficient to melt aluminum by hot gases continuously circulated to the hearth. Molten metal from the hearth flows via gravity into a holding chamber disposed below the hearth. The holding chamber can include at least one immersion heater and a wet roof. Molten metal flows via gravity into a dip well or launder. An aluminum piece charging apparatus can include a part receiving compartment and a mechanism for lifting and feeding the aluminum part to the hearth.

An advantage of the invention is the provision of a high efficiency integrated aluminum melting system comprising in combination, a hearth for receiving a charge of an aluminum piece, a combustion chamber comprising a burner and an after-burner section communicating with said hearth, said fuel burner being adapted to burn hydrocarbon fuel to produce hot gases in said after-burner section for circulation through said hearth for melting the aluminum, a preheat compartment in communication with said hearth for charging aluminum therethrough into said hearth and for conducting a portion of hot gas effluent from said hearth to said compartment in countercurrent flow to said preheat compartment to the after-burner section of said combustion chamber, and for conducting the remainder of said hot gas effluent from said hearth as hot exhaust gases to an exhaust stack, whereby a marked improvement in thermal efficiency is effected per pound of aluminum melted.

In a more particular embodiment, a recuperator is employed to take the remainder of the gas effluent from the hearth and use it to preheat air going into the burner of the combustion chamber. By utilizing the foregoing integrated system, the hot gases leaving the after-burner section can be controlled over a temperature range of about 2000° F. to 2500° F. as compared to temperatures over 3000° F. in conventional systems, with the hot effluent gas leaving the hearth controlled over the range of about 1600° F. to 2000° F., a portion of it being used for preheating the charge, the remainder portion as hot exhaust gases going through the recuperator to the exhaust stack at about 1200° F. to 1500° F.

The stack-melter of the present disclosure advantageously provides fast melting, energy efficiency, relatively low fuel usage, low melt loss (e.g. oxide formation), ease of cleaning and versatility. The stack melting furnace disclosed herein is designed with a hybrid heating system for optimal efficiency. The stack melting furnace also provides optimal metal quality. It can use a low NoX high efficiency gas burner for melting in the stack chamber and immersion heaters in protective heater tubes in the holding, dipwell and/or other furnace chambers. The immersion heating can be done both with electric or gas and also has the ability to be horizontally submerged into the metal bath or vertically submerged. The heater tube can also be designed to always be submerged in molten metal during the process unless draining is required for a shutdown. This can be done by having the heater tubes in a refractory pocket low to the floor and thus allowing metal to pass over the top and into the exit chamber where molten metal is removed from the furnace.

The furnace design can also come with a wet roof package for the holding chamber which will further reduce any chance of oxides forming by leaving no room for air above the molten bath. It will create a sealed refractory environment for the molten metal to always be in contact with on all sides prior to exiting to the adjacent transfer chamber. The heating design employed after the melting process will generate very few, if any, oxides compared to traditional stack melting and it will also provide a more energy efficient system. Additionally, melt loss will be less due to the conductive and indirect nature of the immersion heating.

The dip well or transfer well of the melting furnace will also have an option for filtration in the form of a bonded particle filter (BPF) or multi cartridge tube filter (MCF).

By employing the integrated melting system of the invention, the energy usage or the thermal efficiency can be improved from a range of about 10% to 20% to over 30% and up to about 50%, such as a range of about 40% to 50%, relative to existing designs. The more conventional systems are known to employ fuel inputs of from over 2000 to about 3500 BTU's/hr/lb of aluminum melted; whereas, with the integrated system of the invention, fuel consumption of less than about 2000 BTU's/hr/lb aluminum melted is possible, for example, 1000 BTU's.

By employing the integrated melting system of the invention, a significant reduction in oxide generation can also be achieved. Moreover, by providing a burner chamber, directed flame contact of the metal pieces is avoided. Furthermore, by using immersion heating in the holding chamber, there is a reduction in the introduction of oxygen which is a source of oxide generation. In addition, by forming the holding chamber as a wet roof system, unintentional exposure of the molten metal to oxygen is substantially avoided.

The invention will be clearly apparent from the illustrations, it being understood that the elements making up the system are preferably integrated into a unit design for casting of aluminum parts.

With reference to the Figures, a furnace 10 is shown having a burner section 11, fuel and air being fed to the burner 16 at predetermined ratios to provide hot gases to a melting hearth chamber 13 of the furnace at a temperature of about 2000° F. to 2500° F. The effluent hot gases are fed to melting hearth chamber 13 to melt the aluminum fed thereto via piece loading mechanism 14. A lid 38 can be selectively opened and closed for feeding of the piece(s) and to retain heat during the melting process.

The hot gases for melting the aluminum are produced in the burner section 11. The burner section 11 can include a pocket 15 such that a tip of the burner is distanced from the aluminum pieces/molten aluminum disposed in the hearth 13. The pocket can have a longitudinal axis that is angled relative to a longitudinal axis of the hearth chamber. For example, the pocket longitudinal axis can be angled between 20 and 70 degrees relative to the axis of the hearth chamber. The pocket can expand in radius from its burner receiving end to its hearth intersecting end. The longitudinal axis of the pocket can be configured to intersect a base wall of the combustion chamber.

The tip of the burner resides in the pocket and can be spaced from a surface of the molten metal in the combustion chamber. The combustion chamber can be provided with more than one burners.

Means for feeding preheated air to the burner may be provided wherein the air is drawn through a recuperator, the recuperator being heated by exhaust gases being directed to a stack 31 for discharge to the atmosphere.

The hearth chamber 13 is in fluid communication with a holding chamber 21. The hearth chamber 13 can be physically located above the holding chamber such that gravity can control the flow of molten aluminum through passage 19 between the two vessels. In certain embodiments the hearth is vertically stacked directly above the holding chamber. In certain embodiments the hearth is vertically above the holding chamber but is horizontally off-set.

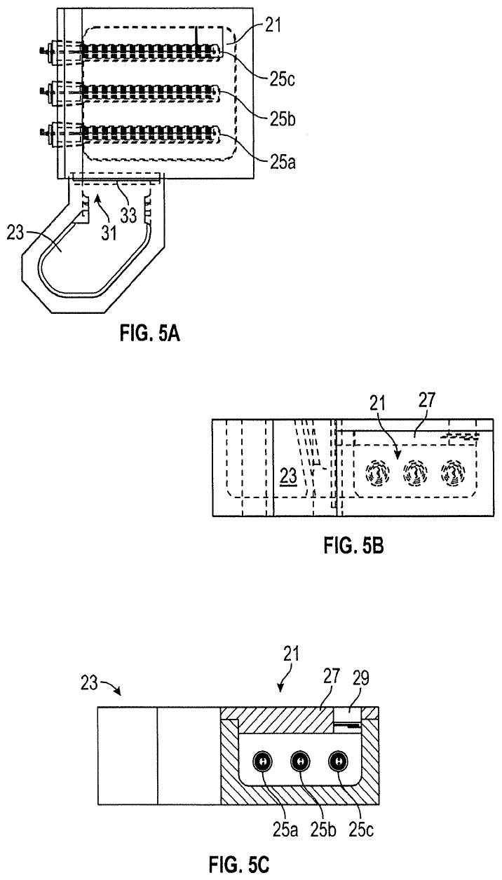

With specific reference to FIGS. 5A-5C, the holding chamber 21 and dip well 23 of the stack-melter furnace are illustrated. The holding chamber can include at least one immersion heater. It is contemplated that the immersion heater(s) are heated by electricity or gas. Three heaters 25a-c are shown having a horizontal orientation. The heater(s) can alternatively have a vertical orientation or a combination of orientations can be used.

Holding chamber 21 is constructed of refractory material such as graphite or ceramic. Holding chamber 21 includes a wet roof 27. This allows operation of the stack furnace in a condition where molten metal is in contact with wet roof 27 such that air is not in contact with a surface of the molten metal within holding chamber 21. The lid can include a gasket and an inert gas port allowing introduction of a layer of an inert gas protecting the molten aluminum from oxidation.

Holding chamber 21 can be provided with an airlock port 29 to where melted molten aluminum would underpour into from the stack/hearth melting chamber. Molten metal is maintained in contact with the wet roof 27 by the gravitational pressure provided by the vertical relationship with the hearth.

Holding chamber 21 can be provided with a sidewall access opening sealed by door 37.

Molten aluminum flows between holding chamber 21 and dip well 23 via passage 31. Molten metal flow between the holding chamber and the dip well is controlled by laser metal level sensors that allow automatic adjustment of the furnace melt rate. A lid 39 can be provided to close dip well 23 when molten metal is not being withdrawn. A filter 33 can be provided in passage 31. Exemplary filters include a bonded particle filter or a cartridge tube filter.

The dip well can also or alternatively include a degassing apparatus. In addition, the disclosure contemplates replacement of the dip well with a launder providing direct flow of molten metal to a casting machine.

In order to maintain a substantially steady state condition once the system is on stream, controls may be employed to control the temperature in the hearth and the holding chamber. Moreover, a thermocouple is coupled to temperature controller, the controller in turn being adapted via coupling to the burner section to control the fuel and combustion air (oxygen) fed to the burner nozzles and the energy fed to the immersion heater(s).

Although the present invention has been described in conjunction with preferred embodiments, it is to be understood that modifications and variations may be resorted to without departing from the spirit and scope of the invention as those skilled in the art will readily understand. Such modifications and variations are considered to be within the purview and scope of the invention and the appended claims.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An integrated aluminum melting and holding system comprising in combination,
a hearth for receiving and melting a charge of aluminum pieces, said hearth including a combustion chamber having a fuel burner section communicating with said hearth for burning hydrocarbon fuel with air to produce effluent hot gases in said burner section for circulation through said hearth for melting the aluminum pieces,
a holding chamber that receives molten aluminum from the hearth, said holding chamber having at least a substantial portion positioned below a substantial portion of the hearth, said holding chamber including at least one immersion heater in contact with the molten aluminum, said holding chamber further including a lid configured for contact with the molten aluminum disposed within the holding chamber, and
an open top well in fluid communication with the holding chamber for receiving the molten aluminum.

2. The aluminum melting system of claim 1, wherein the fuel burner section comprises a pocket disposed in a wall of the combustion chamber, said pocket having a longitudinal axis configured to intersect a base wall of the combustion chamber.

3. The aluminum melting system of claim 2, wherein a tip of a burner resides in the pocket and is spaced from a surface of the molten metal in the combustion chamber.

4. The aluminum melting system of claim 1, wherein the well includes a filtration means.

5. The aluminum melting system of claim 1, wherein the well includes a degassing means.

6. The aluminum melting system of claim 1, wherein the filtration means is a bonded particle filter or a cartridge tube filter.

7. The aluminum melting system of claim 1, wherein the lid includes a gasket and an inert gas introduction port.

8. The aluminum melting system of claim 1, wherein said immersion heater is oriented vertically or horizontally.

9. The aluminum melting system of claim 1, having an aluminum processing capacity of less than 1000 lbs/hour and wherein said aluminum melting system provides molten aluminum to only one or two casting stations.

10. The aluminum melting system of claim 1, including means for sensing the temperature of the effluent hot gases flowing from said burner section and for varying the amount of hydrocarbon fuel and air fed to said fuel burner in accordance with the temperature sensed; and means for sensing the temperature of molten aluminum in the hearth and for varying the energy provided to the immersion heater based on the temperature of the molten aluminum sensed.

11. The aluminum melting system of claim 1, including an additional scrap-receiving preheat compartment communicating with said hearth and adapted for feeding scrap aluminum to said hearth for melting therein.

12. The aluminum melting system of claim 1, wherein the immersion heater is heated using one of gas or electricity.
